(19) United States
(12) Patent Application Publication
(10) Pub. No.: US 2005/0232558 A1
(43) Pub. Date: Oct. 20, 2005

(54) Method of distributing and laying optical fiber cables

(76) Inventors: Nobuhiro Gotou, Kyoto (JP); Youichi Ikemoto, Kyoto (JP); Hiroki Sueyoshi, Kyoto (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/516,301

(22) PCT Filed: Jun. 16, 2003
(86) PCT No.: PCT/JP03/07624

§ 371 Date: Dec. 9, 2004

(30) Foreign Application Priority Data
Jun. 17, 2002 (JP) 2002-175964

(51) Int. Cl. G02B 6/06

(52) U.S. Cl. 385/116

(57) ABSTRACT

When optical fiber cables drawn into a building from a trunk cable are to be distributed inside the building, optical fiber cables 1 are passed through a gutter or drain pipe 2. The occupied cross-sectional area of the optical fiber cables 1 is preferably equal to or less than 50% of the cross-sectional area of the gutter or drain pipe 2. When a branch pipe is connected to the gutter or drain pipe 2, at the portion where the branch pipe is connected to the gutter or drain pipe 2, the optical fiber cables passed through the gutter or drain pipe are gathered at an inner side of the gutter or drain pipe opposite to the connection portion. A partition plate or a support including concavo-convex portions in which plural optical fiber cables can be disposed is disposed inside the gutter or drain pipe 2, or the optical fiber cables are laid in a state where they are passed through a sheath tube or sheath tubes where plural sheath portions are laterally coupled together.

### TECHNICAL FIELD

The present invention relates generally to a method of distributing and laying optical fiber cables, and, more particularly, to an optical fiber cable distribution and laying method used when distributing and installing optical fiber cables, drawn into a building where homes or offices are concentrated, to and in each home or each office in that building.

### BACKGROUND ART

Conventionally, communication using telephone lines and wireless communication have been the most prevalent modes of information communication, but there is a limit on the ability of these modes of communication to accommodate increases in the volume of information and the speed at which that information is transmitted. In contrast, information communication using optical fiber has a high transmission capability and is serving as an influential communication mode of the next generation because it can accommodate gigabit-level (Gbps) high-speed communication, there is little cross talk and there are few affects on other devices in comparison to copper cables.

With information communication using optical fiber, two-way communication of moving images and real-time communication over a long distance become possible. In order to conduct such communication, it is necessary to distribute and install, to each room within the building, optical fiber cables drawn to a main distribution frame (MDF) of the building from a trunk cable (FTTH: Fiber To The Home).

However, when distributing and installing optical fiber cables within a building such as a multidwelling building or an office building, an attempt is presently being made to distribute the optical fiber cables through existing pipes such as those for common phone lines, and ordinarily there are many instances where it is not assumed beforehand that optical fiber cables will be passed through these existing pipes, so that oftentimes the existing pipes become blocked in the middle of drawing the optical fiber cables therethrough, and the cables cannot be passed through the pipes. Also, ordinarily a drop in the performance of the optical fiber cables resulting from bending becomes a problem, and there is the problem that when the optical fiber cables are bent at a sharp angle, a disturbance arises in the reflection angle of the light and transmission loss drastically increases. It is also easy for the optical fiber cables themselves to break if one attempts to carelessly draw them.

In order to solve this problem, Japanese Patent Application Laid-Open Publication (JP-A) No. 60-22408 proposes a laying method where communication cables such as optical fiber cables are retained beforehand at the inner surface of an inversion-type cylindrical lining tube and the lining tube is inserted inside a fluid conduit such as a gas pipe so that the inner and outer surfaces of the cylindrical lining tube are inverted, whereby the communication cables are laid between the fluid conduit and the cylindrical lining tube.

However, although the method disclosed in JP-A No. 60-22408 can reduce damage resulting from friction, tension is applied to the communication cables because the inverted lining tube is adhered and fixed to an existing tube while using fluid pressure to invert the inversion-type lining tube within the conduit. Depending on the case, it is also assumed that the communication cables become entwined, the insertion resistance becomes too large and the communication cables break. There is also the problem that this method is extremely time-consuming because it comprises the step of retaining the communication cables at the inner surface of the lining tube, the step of injecting fluid, and the step of adhering and fixing the lining tube to an existing pipe.

Moreover, split portions left aside, in the method using inversion and insertion, it is extremely difficult to pass the lining tube at 90° bent portions of the existing tube. Also, because there are very few instances where the pipes in residential or office buildings are straight, there has been the problem that it is difficult for this method to accommodate such existing pipes. Moreover, there has been the problem that the method using inversion and insertion cannot accommodate instances where additional communication cables are disposed once the communication cables have been inserted.

In light of these problems with conventional optical fiber cable distribution and laying methods, it is an object of the present invention to provide an optical fiber cable distribution and laying method that is suitable to use when distributing and installing optical fiber cables in buildings such as residential or office buildings, and to provide an optical fiber cable distribution and laying method that can also accommodate high-rise condominium buildings, is simple, has excellent installability and is economical.

### DISCLOSURE OF THE INVENTION

The optical fiber cable distribution and laying method of the invention is a method of distributing and laying, inside a building, optical fiber cables drawn into the building from a trunk cable, the method comprising passing the optical fiber cables through the inside of a gutter or drain pipe.

According to this configuration, in contrast to the conventional case where optical fiber cables are passed through existing pipes having many bend portions, the cables can be smoothly laid without the bend radius of the cables exceeding the limit and without the cables sustaining damage.

In the above configuration, the occupied cross-sectional area of the optical fiber cables passed through the inside of the gutter or drain pipe is preferably equal to or less than 50% of the cross-sectional area of the inside of the gutter or drain pipe.

By employing this configuration, a sufficient flow path for rain water flowing through the inside of the gutter or drain pipe can be ensured, and blockage of the flow path can be prevented.

Here, “occupied cross-sectional area of the optical fiber cables” means the total cross-sectional area of each optical fiber cable. Also, “cross-sectional area of the inside of the gutter or drain pipe” means the total cross-sectional area of the inside of the gutter or drain pipe. This cross section refers to the cross-section that appears when the gutter or drain pipe is cut perpendicularly with respect to the longitudinal direction of the gutter or drain pipe.

It is preferred that a branch pipe be connected to the gutter or drain pipe, and that at the portion where the branch pipe is connected to the gutter or drain pipe, the optical fiber cables passed through the inside of the gutter or drain pipe be gathered at an inner side of the gutter or drain pipe opposite to the connection portion.

By employing this configuration, a flow path at the connection side of the branch pipe can be ensured in addition to the above action and effects.

A partition plate may be disposed inside the gutter or drain pipe.

A sheath tube may be passed through the inside of the gutter or drain pipe, with the optical fiber cables being passed through the sheath tube. Sheath tubes having a plurality of sheath portions laterally coupled together may be passed through the inside of the gutter or drain pipe, with the optical fiber cables being passed through the sheath tubes.

A support having concavo-convex portions capable of arranging and supporting a plurality of optical fiber cables may be disposed inside the gutter or drain pipe.

### BRIEF DESCRIPTION OF THE DRAWINGS

FIG. 1 is a schematic cross-sectional view showing an example of an optical fiber cable distribution and laying method pertaining to the invention;

FIG. 2 is a schematic cross-sectional view showing another example in regard to the optical fiber cable distribution and laying method pertaining to the invention;

FIG. 3 is a schematic cross-sectional view showing yet another example in regard to the optical fiber cable distribution and laying method pertaining to the invention;

FIG. 4 is a schematic cross-sectional view showing still another example in regard to the optical fiber cable distribution and laying method pertaining to the invention;

FIG. 5 is a schematic cross-sectional view showing yet another example in regard to the optical fiber cable distribution and laying method pertaining to the invention;

FIG. 6 is a schematic cross-sectional view showing still another example in regard to the optical fiber cable distribution and laying method pertaining to the invention; and

FIG. 7 is a schematic perspective view for describing an example where optical fiber cables are distributed and laid to each room using the optical fiber cable distribution and laying method pertaining to the invention.

### BEST MODE FOR CARRYING OUT THE INVENTION

An embodiment of the present invention will now be described in detail with reference to the drawings.

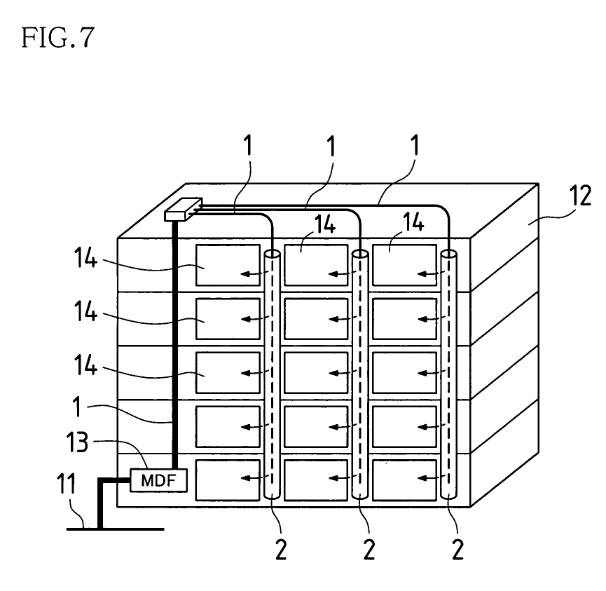

As shown in FIG. 7 for example, an optical fiber cable distribution and laying method of the present embodiment is one where optical fiber cables 1 drawn from a trunk cable 11 to an MDF chamber 13 of a building 12, which is a five-story apartment building, are split on the roof, passed through gutters or drain pipes 2, drawn to each home 14 within the building 12 and distributed.

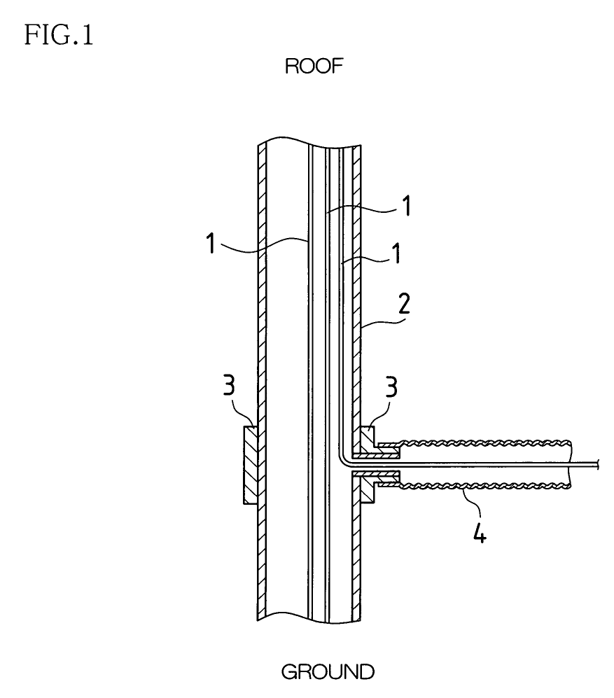

FIG. 1 is a schematic cross-sectional view (vertical direction) showing the inside of one of the gutters or drain pipes 2 in an example of the optical fiber cable distribution and laying method pertaining to the invention. In the laying method shown in FIG. 1, plural optical fiber cables 1 necessary to draw optical fiber cables within the building are dropped through the gutter or drain pipe 2 and passed through a branch pipe 4 via a branch coupler 3 at each floor, whereby the optical fiber cables 1 are distributed to each home or office within the building 12 in a state where the optical fiber cables 1 are protected.

The present embodiment is particularly suitable for multidwelling residential buildings, such as apartment buildings constructed by the Housing and Urban Development Corporation, apartment buildings and condominiums, in that numerous optical fiber cables can be collectively drawn at one time.

The type of optical fiber cables 1 is not particularly limited. Ordinarily, two-fiber cables or multifiber cables are used. Ordinarily, two-fiber cables are useful when splitting the optical fiber cables to each home, but when optical fiber cables are split collectively to a plural number of homes, multifiber cables are useful in terms of the occupied area with respect to the insides of the gutters or drain pipes 2, and the most appropriate cables are selected depending on the installation site.

Quartz optical fiber and plastic optical fiber (POF) are preferably used as the material of the optical fiber used for the optical fiber cables. Among these, plastic optical fiber is preferable in that it has an excellent ability to be bent at split portions.

Examples of such plastic optical fiber include plastic optical fiber having a GI type (refractive index distribution) or multilayer cross-sectional type structure. Examples of the material for the core and clad of the optical fiber include fluorine, acrylic, polycarbonate, norbornene and cyclic olefin polymers. Among these, a fluorine polymer is preferable in terms of its transmission capability.

The gutters or drain pipes 2 are not particularly limited, and existing gutters and drain pipes disposed in the building may be used, for example. When existing gutters or drain pipes are used, it is not necessary to lay new pipe lines, and the cables can be simply and economically laid. Also, because gutters or drain pipes are used as the pipes, fluids do not flow continuously across the entire volume inside the pipes, and there are no problems with respect to the air-tightness, water-tightness and safety of the pipe lines.

In the present embodiment, when cables of the number necessary for each floor are split, holes may be formed with a hole saw in the side surfaces of the gutters or drain pipes 2, and the branch couplers 3 can be used as shown in FIG. 1. Examples of the branch couplers 3 include halved branch couplers, and it is preferable to form holes with a hole saw in the side surfaces of the gutters or drain pipes 2, attach halved branch couplers, and draw and lay the necessary cables.

The branch pipes 4 are not particularly limited. For example, accordion-fold waveform electrical conduits are preferable in terms of their excellent flexibility.

The method for disposing, inside the homes and offices, the cables drawn through gutters to verandas of the building is not particularly limited, and a conventionally known method can be used. For example, the cables may be passed through gaps in air conditioner ducts or ventilation fans, or a method using existing lead cable holes may be used.

In the present embodiment, it is preferable for the occupied area of the optical fiber cables 1 passed through the insides of the gutters or drain pipes 2 to be equal to or less than 50% of the cross-sectional area inside the gutters or drain pipes 2. This is preferable because a sufficient flow path for rain water flowing through the insides of the gutters or drain pipes 2 can be ensured, and blockage of the flow path can be prevented. Here, “occupied cross-sectional area of the optical fiber cables 1” means the total cross-sectional area of each optical fiber cable 1, and “cross-sectional area of the insides of the gutters or drain pipes 2” means the total cross-sectional area (lateral direction) of the insides of the gutters or drain pipes 2 themselves.

Also, with respect to the connection portions where the branch pipes for drainage from the veranda are connected to the gutters or drain pipes 2, it is preferable for the optical fiber cables passed through the insides of the gutters or drain pipes 2 to be gathered at the side opposite to the branch pipe connection side. Due to the optical fiber cables being gathered at the opposite side, a flow path for drainage at the branch pipe connection side can be ensured, and it becomes difficult for problems such as blockage to occur.

In the present embodiment, “side opposite to the branch pipe connection side” means the opposite side direction with respect to the side of the branch pipe connection side inside the gutters or drain pipes 2. In the present embodiment, a method where the optical fiber cables are partially bonded, using adhesive tape, and gathered in the direction of the side of the semicircular portion opposite to the branch pipe connection side in the cross section (lateral direction) of the pipe, or a method where fixing with jigs is conducted, is adopted.

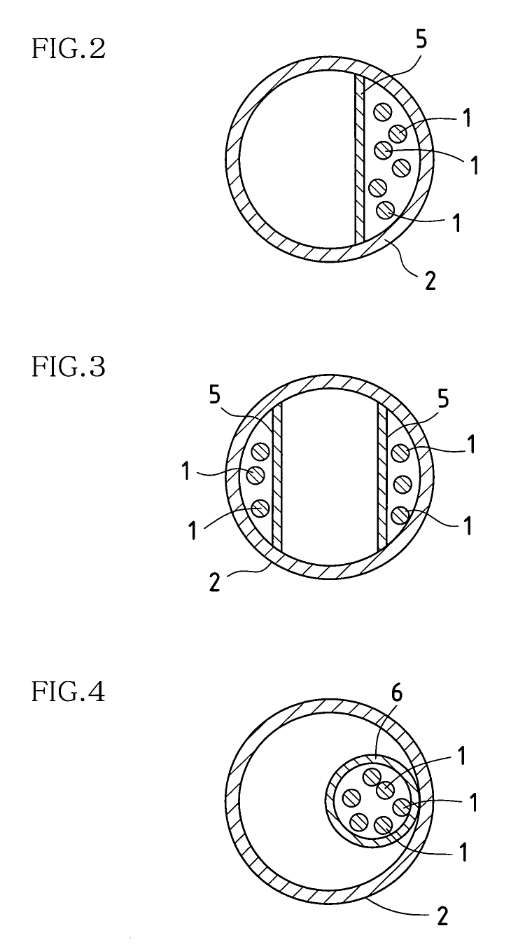

In the present embodiment, when the optical fiber cables 1 are passed through the gutters or drain pipes 2, a partition plate 5 may be used as shown in FIG. 2 to ensure a path for the cables in order to prevent the drainability of the gutters or drain pipes 2 from dropping or being compromised. In this case, it is preferable for the path of the cables to be disposed at the side where the cables are split and pulled out. When it is necessary to pull out the cables at both sides, paths for the cables can be disposed at both sides as shown in FIG. 3 using plural partition plates 5.

There are no particular limitations on the material for the partition plate 5 as long as the material has strength for ensuring the path, and any suitable material can be selected.

Also, it is known that when moisture penetrates optical fiber, usually reflectance characteristics with respect to light, which is the transmission medium, deteriorate and the transmission efficiency significantly drops; but as described above, moisture can be prevented from penetrating the optical fiber by disposing a cover that can prevent the penetration of rain water at the uppermost portion of the cable path in the gutters or drain pipes 2. Thus, long-term deterioration can be prevented.

As shown in FIG. 4, the present embodiment may also be configured so that the optical fiber cables 1 are passed through a sheath tube 6 and drawn through the gutter or drain pipe 2. In this case, the sequence by which the optical fiber cables 1 are passed is not particularly limited. For example, the sheath tube 6 may first be passed through the gutter or drain pipe 2 and then the optical fiber cables 1 may be passed through the sheath tube 6, or the optical fiber cables 1 may first be passed through the sheath tube 6 and then the sheath tube 6 may be passed through the gutter or drain pipe 2. Although it is not illustrated, each optical fiber cable may also be passed through a separate sheath tube.

By passing the cables through the sheath tube 6, the cables themselves can be more reliably protected from rain water.

The sheath tube 6 is not particularly limited, but a sheath tube made of plastic is preferable in terms of its installability. For example, a vinyl chloride tube or a polyethylene tube is suitable.

When the optical fiber cables 1 passed through the sheath tube 6 are to be split, the necessary cables can be laid via branch couplers by forming holes in the necessary portions of the sheath tube 6.

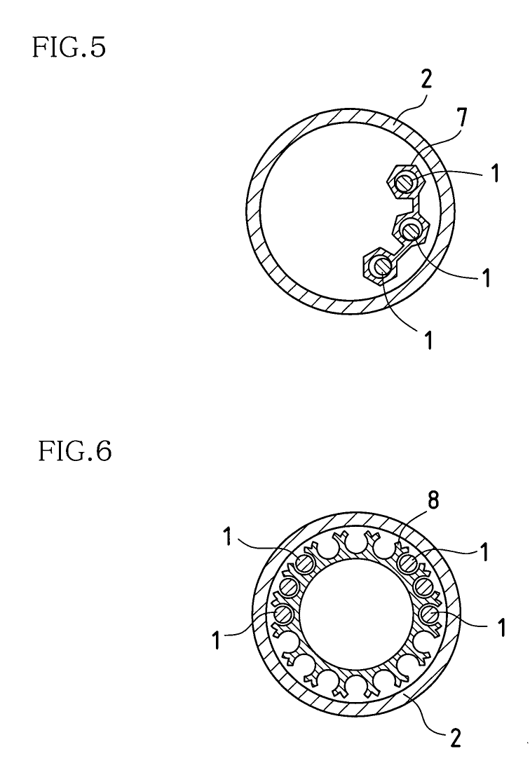

As shown in FIG. 5, sheath tubes 7 where plural sheath portions are laterally coupled together may be used, and the optical fiber cables 1 may be passed through those sheath portions and drawn through the gutter or drain pipe 2. In this case, the sequence by which the optical fiber cables 1 are passed is not particularly limited. For example, the sheath tubes 7 may first be passed through the gutter or drain pipe 2 and then the optical fiber cables 1 may be passed through the sheath tubes 7, or the optical fiber cables 1 may first be passed through the sheath tubes 7 and then the sheath tubes 7 may be passed through the gutter or drain pipe 2.

In this configuration, when the optical fiber cables 1 passed through the sheath tubes 7 are to be split, the coupled portions of the sheath portions through which the necessary cables are passed may be cut and separated by splitting the coupled portions, and the optical fiber cables 1 may be laid via branch couplers together with the sheath portions where the cables are separated.

When using the sheath tubes 7 where plural sheath portions are coupled together, the optical fiber cables 1 can be laid without becoming tangled, and the cables can be simply removed at the time they are split, which is preferable in terms of workability. The material of the sheath tubes 7 is not particularly limited, but sheath tubes made of plastic are preferable in terms of installability. In particular, LDPE (low density polyethylene), soft polyvinyl chloride resin or soft urethane resin is preferable in that the ability of the coupled portions to be split is excellent. Also, the cross-sectional shape of the sheath tubes 7 is not particularly limited; for example, sheath tubes where sheath portions having a circular shape are laterally coupled together may be used, or sheath tubes where sheath portions having a polygonal shape are laterally coupled together may be used.

As shown in FIG. 6, the present embodiment may also be configured using a support 8 having concavo-convex portions with which plural optical fiber cables can be disposed and supported inside the gutter or drain pipe 2, so that the optical fiber cables are lead through the gutter or drain pipe 2. In this case, the sequence by which the optical fiber cables 1 are passed is not particularly limited. For example, the support 8 may first be passed through the gutter or drain pipe 2 and then the optical fiber cables 1 may be disposed in the support 8, or the optical fiber cables 1 may first be disposed in the support 8 including the concavo-convex portions and then the support 8 may be passed through the gutter or drain pipe 2. Alternatively, a certain amount of the optical fiber cables 1 may be disposed in the support 8 including the concavo-convex portions, and then cables may be sequentially disposed in the concavo-convex portions of the support 8 while the support 8 is fed through the gutter or drain pipe 2.

In the present embodiment, when the cables are to be split, the necessary number of optical fiber cables 1 can be removed from the concavo-convex portions of the support 8 and laid via branch couplers.

The material of the support 8 is not particularly limited, but it is preferable to use a material with a high elasticity modulus because it is easy to position the fiber when passing the cables through the gutter or drain pipe 2.

As described above, with the optical fiber cable distribution and laying method of the present embodiment, the optical fiber cables are passed through gutters or drain pipes already laid in a building and are not passed through narrow pipes where there are many bent portions as with those for common telephone lines. Thus, a laying method that is simple and has excellent installability can be provided without it being difficult to pass the optical fiber cables.

Ordinarily, the limit of the bend radius of optical fiber is 30 R (bend radius) in the case of plastic optical fiber, and when plastic optical fiber cables are passed through existing indoor pipes having bends in the vicinity of this limit, there are instances where the optical fiber sustains damage and the transmission capability is compromised due to breakage inside when the cables are carelessly passed through these pipes.

With the optical fiber cable distribution and laying method of the present embodiment, when optical fiber cables are to be laid via branch couplers, the cables can be pulled out from the split portions and laid inside the building while visually confirming the bend radius. Thus, the cables can be laid without the optical fiber sustaining damage.

Also, when the cables are to be passed, the cables can be efficiently laid in the building without compromising the inherent drainability of the gutters or drain pipes, by using partition plates or supports or by passing the optical fiber cables through sheath portions.

Next, the invention will be described in greater detail by way of an example and a comparative example.

It should be noted that the invention is in no way limited to only the following example.

### EXAMPLE 1

10 two-fiber fluorine optical fiber cables (LUCINA (trade name) made by Asahi Glass Co., Ltd.) were dropped from the roof of a 10-story condominium building through a φ75 existing downspout. Next, a φ50 mm hole was formed with a hole saw in the side surface of the downspout at the distribution and installation portion of the tenth floor, and the optical fiber cables were pulled out by hand.

Next, a φ75 halved branch coupler was disposed in the side surface portion of the downspout in which the hole had been formed with the hole saw, the optical fiber cables were passed from the branch portion of the coupler and distributed to the veranda of the tenth floor through a waveform electrical conduit (ESLOFLEKI-PF(trade name) made by Sekisui Chemical Co., Ltd.).

The above work was conducted in order from the ninth floor to the first floor, and finally a porous drain cover was disposed at the uppermost portion of the downspout on the roof, whereby the work was completed.

### COMPARATIVE EXAMPLE 1

10 optical fiber cables that were the same as those used in Example 1 were drawn in an exposed pipe to the first floor of a 10-story condominium building, and thereafter the optical fiber cables were passed through a common pipe shaft and distributed and installed to each floor, but the optical fiber cables became blocked in the middle of the pipe shaft and could not be laid.

### INDUSTRIAL APPLICABILITY

Conventionally, in order to achieve so-called FTTH in a building such as a residential or building, detached houses aside, suitably laying plural optical fiber cables in multidwelling residential buildings, such as apartment buildings constructed by the Housing and Urban Development Corporation, apartment buildings and condominiums, has been a large problem. But according to the optical fiber cable distribution and laying method of the present invention, an optical fiber cable distribution and laying method that can also accommodate high-rise condominium buildings, is simple, has excellent installability and is economical can be provided.

1. A method of distributing and laying, inside a building, optical fiber cables drawn into the building from a trunk cable, the method comprising passing the optical fiber cables through the inside of a gutter or drain pipe.

2. The method of distributing and laying optical fiber cables of claim 1, wherein the occupied cross-sectional area of the optical fiber cables passed through the inside of the gutter or drain pipe is equal to or less than 50% of the cross-sectional area of the inside of the gutter or drain pipe.

3. The method of distributing and laying optical fiber cables of claim 1 or 2, wherein a branch pipe is connected to the gutter or drain pipe, and wherein at the portion where the branch pipe is connected to the gutter or drain pipe, the optical fiber cables passed through the inside of the gutter or drain pipe are gathered at an inner side of the gutter or drain pipe opposite to the connection portion.

4. The method of distributing and laying optical fiber cables of claim 1 or 2, wherein a partition plate is disposed inside the gutter or drain pipe.

5. The method of distributing and laying optical fiber cables of claim 1 or 2, wherein a sheath tube is passed through the inside of the gutter or drain pipe, and wherein the optical fiber cables are passed through the sheath tube.

6. The method of distributing and laying optical fiber cables of claim 1 or 2, wherein sheath tubes having a plurality of sheath portions laterally coupled together are passed through the inside of the gutter or drain pipe, and wherein the optical fiber cables are passed through the sheath tubes.

7. The method of distributing and laying optical fiber cables of claim 1 or 2, wherein a support having concavo-convex portions capable of arranging and supporting a plurality of optical fiber cables is disposed inside the gutter or drain pipe.
